(19) United States
(12) Patent Application Publication
(10) Pub. No.: US 2014/0237268 A1
(43) Pub. Date: Aug. 21, 2014

(54) MOISTURE SHUTDOWN CONTROL

(71) Applicant: BROADCOM CORPORATION, Irvine, CA (US)

(72) Inventor: Murat Mese, Rancho Palos Verdes, CA (US)

(73) Assignee: Broadcom Corporation, Ivrine, CA (US)

(21) Appl. No.: 13/849,172

(22) Filed: Mar. 22, 2013

Related U.S. Application Data
(60) Provisional application No. 61/766,429, filed on Feb. 19, 2013.

(51) Int. Cl. G06F 1/26

(52) U.S. Cl. CPC G06F 1/26
USPC 713/300

(57) ABSTRACT

Aspects of shutdown control of a device in the presence of moisture are described. In one embodiment, a moisture detection signal is received from a moisture detector. In turn, certain parameters associated with the moisture detector are identified. For example, the location of the moisture detector may be identified. Additionally or alternatively, a probability for damage to the device, based on the location of the moisture detector, may be identified. An evaluation of the moisture detection signal and the identified parameters is performed. Based on the evaluation, one of various power down procedures for the device may be initiated. In certain cases, a quick power down reaction for one or more subsystems of the device, in response to the detection of moisture, may prevent damage to the device.

### CROSS-REFERENCE TO RELATED APPLICATIONS

This application claims the benefit of U.S. Provisional Application No. 61/766,429, filed Feb. 19, 2013, the entire contents of which is hereby incorporated herein by reference.

### BACKGROUND

Electronic devices are being widely adopted for use in various everyday activities. As the devices are operated readily by users in various activities, the devices may be exposed to a wide range of environmental conditions over a period of time. For example, a device may be exposed to relatively cold and warm environments and relatively dry and humid environments. Generally, devices and components of the devices are designed to withstand a certain range of environmental conditions. However, many modern electronic devices are not designed to handle extreme environmental conditions.

Especially for handheld electronic devices, the likelihood that the devices will be exposed to extreme environmental conditions is heightened, because the devices are more likely to be dropped or misplaced. Additionally, because handheld devices are relatively small, they are more likely to be forgotten or misplaced in extreme environments.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates an example host device that incorporates elements for moisture control shutdown according to various embodiments described herein.

FIG. 2 illustrates relative positions of subsystem components and sensors in the host device of FIG. 1 in a cross-section of the host device, according to various embodiments described herein.

FIG. 3 illustrates an example process flow of a process for moisture shutdown control performed by the host device of FIG. 1 according to various embodiments described herein.

FIG. 4 illustrates an example process flow of a process for evaluating parameters for moisture shutdown performed by the host device of FIG. 1 according to various embodiments described herein.

FIG. 5 illustrates an example process flow of a shutdown sequence process performed by the host device of FIG. 1 according to various embodiments described herein.

FIG. 6 illustrates an example schematic block diagram of a computing architecture that may be employed by the host device of FIG. 1 according to various embodiments described herein.

### DETAILED DESCRIPTION

Electronic devices are being widely adopted for use in various everyday activities. As the devices are operated readily by users in various activities, the devices may be exposed to a wide range of environmental conditions over a period of time. For example, a device may be exposed to relatively cold and warm environments and relatively dry and humid environments. Especially for handheld electronic devices, the likelihood that the devices will be exposed to extreme environmental conditions is heightened, because the devices are more likely to be dropped. In some cases, when devices are dropped, they fall into areas that are wet.

Generally, devices and components of the devices are designed to withstand a certain range of environmental conditions. However, many modern electronic devices are not designed to handle exposure to, or submersion in, water or other liquids. Exposure to water may lead to corrosion, oxidation, residue crystallization, and the creation of short circuits among circuitry. One important aspect to preventing damage to electronic devices when exposed to moisture is disconnection of the device's circuitry from power. Many circuits inside a cellular telephone, for example, can survive immersion in water provided they are not attached (or are quickly disconnected from) a power source.

In this context, aspects of shutdown control of a device in the presence of moisture are described. In one embodiment, a moisture detection signal is received from a moisture detector. In turn, certain parameters associated with the moisture detector or the moisture detection signal are identified. For example, a physical location of a moisture detector may be identified using a table of known locations of moisture detectors within a device, based on the product design of the device. Additionally or alternatively, a probability for damage to the device, based on the location of the moisture detector, may be identified. An evaluation of the moisture detection signal and the identified parameters is performed. Based on the evaluation, one of various power down procedures for the device may be initiated. In certain cases, a quick power down reaction for one or more subsystems of the device, in response to the detection of moisture, may prevent damage to the device.

Turning now to the drawings, a general description of an example host device that incorporates elements for moisture control shutdown are provided, followed by a discussion of the operation of the same.

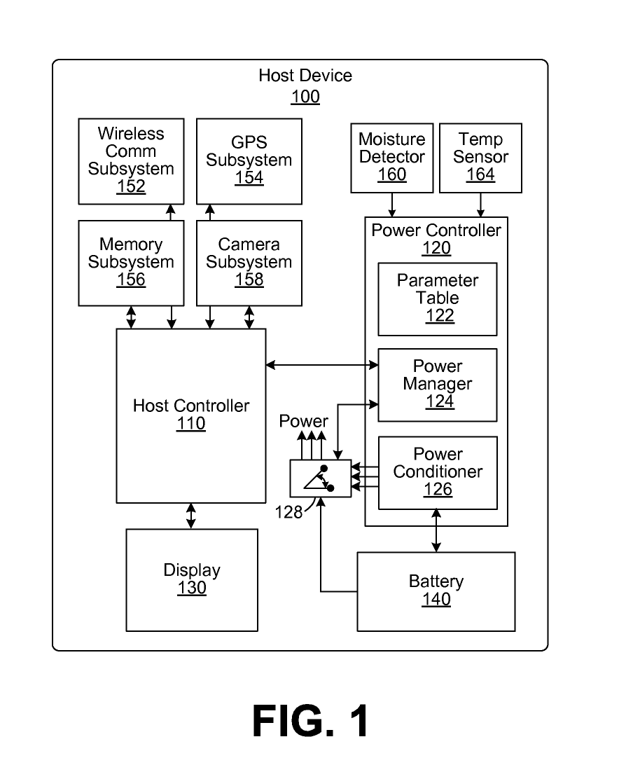

FIG. 1 illustrates an example host device 100 that incorporates elements for moisture control shutdown according to various embodiments described herein. As illustrated, the host device 100 comprises a host controller 110, a power controller 120, a display 130, and a battery 140. Further, the host device 100 comprises various subsystems, including a wireless communications subsystem 152, a Global Positioning System (GPS) subsystem 154, a memory subsystem 156, and a camera subsystem 158. In various embodiments, the host device 100 also comprises one or more sensors. As illustrated in FIG. 1, the host device 100 comprises a moisture detector 160 and a temperature sensor 164. It should be appreciated that the elements of the host device 100 illustrated in FIG. 1 are provided by way of example only, as additional or alternative elements of the host device 100 are within the scope and spirit of the embodiments described herein. For example, the host device 100 may further include a speaker, microphone, camera, keypad, light emitting diodes (LEDs), memory card slot, and subscriber identity module (SIM) card slot, among other elements.

The wireless communications subsystem 152 comprises integrated circuitry and/or individual circuit components that support wireless communications between the host device 100 and various access stations, such as wireless local area network (WLAN) base stations, access points, and cellular access towers of cellular communications networks. To this end, the wireless communications subsystem 152 may include mixed analog/digital circuits, chips, or system-on-chip circuitry. The wireless communications subsystem 152 may also include one or more antennas, mixers, and duplexers, filtering circuitry (e.g., band pass, band stop, and cellular blocking filters), and amplifiers to support wireless communications.

The GPS subsystem 154 comprises integrated circuitry and/or individual circuit components that support global positioning system data collection for the host device 100. By the GPS subsystem 154, the host device 100 is able to determine its geographic position with relative accuracy. The memory subsystem 156 comprises integrated circuitry and/or individual circuit components that store data for the host device. In one aspect of the memory subsystem 156, the subsystem stores executable instructions for reference, retrieval, and execution by the host controller 110. In various embodiments, the host controller 110 may comprise volatile and non-volatile portions or sections of circuitry. Further aspects and example embodiments of the memory subsystem are described below. The camera subsystem 158 comprises integrated circuitry and/or individual circuit components, such as an image sensor, that support the operations of a camera and the capture of digital images.

The host controller 110 generally coordinates overall operation of the features of the host device 100. Particularly, the host controller 110 executes various applications for the host device 100, and coordinates the operation of the applications with the subsystems 152, 154, 156, and 158. As further described herein, the host controller 110 may retrieve executable instructions from the memory subsystem 156. Upon execution of these instructions, the host controller 110 may be configured to perform or execute applications and other underlying processes relied upon by the host device 100.

It is noted that certain applications executing at the direction of the host controller 110 rely upon one or more of the subsystems 152, 154, 156, and 158 for operation. For example, a telephone application of the host controller 110 may rely upon the wireless communications subsystem 152, at least in part, to establish and connect a telephone call. Similarly, a navigation-based application may rely upon the GPS subsystem 154 to determine a geographic location and provide instructions for navigation. During operation, the host controller 110 also controls output to the display 130.

Here, it is noted that the host controller 110, the display 130, and the subsystems 152, 154, 156, and 158, among other elements of the host device 100, rely upon a supply of power from the battery 140. As further described below, power is generally supplied from the battery 140 to the elements of the host device 100 at the direction of the power controller 120.

The power controller 120 comprises a parameter table 122, a power manager 124, and a power conditioner 126. Generally, the power controller 120 coordinates the control and distribution of power from the battery 140 to the host controller 110, the display 130, the subsystems 152, 154, 156, and 158, and other elements of the host device 100. In certain aspects, the power manager 124 relies upon variables or parameters stored in the parameter table 122 to determine when power should or should not be coupled to the elements of the host device 100. The parameters are related to attributes of the moisture detector 160 or a moisture detection signal generated by the moisture detector 160 and, in some aspects, the temperature sensor 164. Reliance upon the parameter table 122 by the power manager 124 is described in further detail below.

The power conditioner 126 comprises circuitry that conditions power output from the battery 140 into suitable voltage and current supplies necessary for the host controller 110, the display 130, and the subsystems 152, 154, 156, and 158, for example. In other words, depending upon the power requirements of the host controller 110, the power conditioner 126 may regulate voltage and current provided from the battery 140 to a suitable level of voltage and a suitable supply of current for the host controller 110. Similarly, for each of the display 130 and the subsystems 152, 154, 156, and 158, the power conditioner 126 may regulate power provided from the battery 140 to suitable levels of voltage and current. Thus, as illustrated in FIG. 1, the power conditioner 126 may provide a respective supply of power to individual circuit elements of the host device 100.

In the host device 100, a switch 128 is interposed between the power supply output from the power conditioner 126 and the elements of the host device 100. The switch 128 electrically couples or disconnects power supplied form the power conditioner 126 to circuit elements of the host device, at the control of the power manager 124. Particularly, for one or more of the circuit elements of the host device 100, respectively, the switch 128 may connect or disconnect the supply of power from the power conditioner 126 and/or the battery 140. In other words, in the host device 100, power may be electrically coupled to various circuits within the host device 100, by respective power traces or suitable connections for the distribution of power. The switch 128 may be interposed among each of these connections, such that the power manager 124 can control the disconnection and connection of the supply of power to the respective elements. Thus, the switch 128 provides a flexible means to disconnect and connect power to individual circuit elements of the host device 100, such as the host controller 110, the display 130, and the subsystems 152, 154, 156, and 158.

The switch 128, in various embodiments, comprises a plurality of switches, each suitable for the application of switching power to circuit elements within the host device 100. For example, the switch 128 may comprise one or more semiconductor-based switches, such as a solid-state relays, transistors, triacs, etc. It should be appreciated that, in various embodiments, the switch 128 may be interposed between both the battery 140 and other circuit elements of the host device 100 and the power conditioner 126 and other circuit elements of the host device.

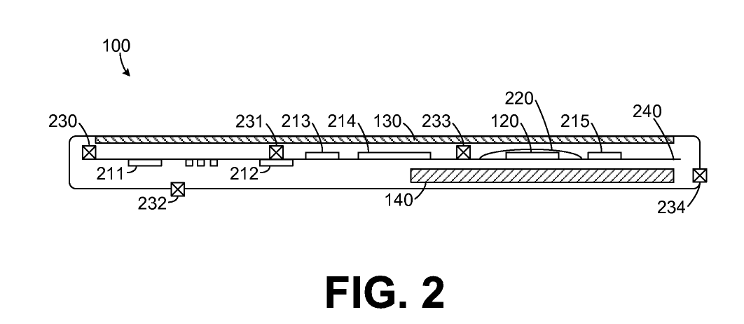

The moisture detector 160 comprises a sensor that detects relative levels of moisture. For example, in various embodiments, the moisture detector 160 may be able to detect relative levels of humidity and/or relative levels of moisture (e.g., water or wetness). The detector 160 may comprise a semiconductor-based moisture bridge, for example, or any other suitable means for the detection of relative levels of moisture, humidity, or wetness. The temperature sensor 164 comprises a sensor that detects a temperature at a certain location within the host device 100. The moisture detector 160 and/or the temperature sensor 164 may provide digital or analog feedback signals to the power controller 120. Using the feedback signals, the power controller 120 generally operates to evaluate conditions for the host device 100 and, in some cases, initiate a power down procedure for the host device. In other aspects, as further described below in connection with FIG. 2, the moisture sensor 160 may comprise several moisture sensors positioned at various locations within the host device 100.

The power manager 124, in one example, receives an indication of the detection of moisture from the moisture detector 160. In various embodiments, the indication of the detection of moisture may be provided from the moisture detector 160 in the form of a moisture detection signal. It should be appreciated that the moisture detection signal may comprise an analog signal that is representative of an amount of moisture detected by the moisture detector 160. In other cases, the moisture detection signal may comprise a digital signal that indicates whether moisture is detected or not, but not a representative level of an amount of moisture detected. Further, with reference to the parameter table 122, the power manager 124 identifies, accesses, or calculates certain parameters associated with the moisture detector 160. For example, the power manager 124 may determine or identify the location of the moisture detector 160 within the host device 100. If the moisture detector 160 is proximate to a moisture-sensitive circuit element of the host device 100, then the power manager 124 may determine that there is a high probability for damage. In this case, the power manager 124 may proceed to perform a quick power down of the host device 100.

Additionally or alternatively, the power manager 124 identifies, accesses, or calculates certain parameters associated with the moisture detection signal. For example, the power manager 124 may determine or identify whether the moisture detection signal has crossed a certain threshold, maintained a certain level for a predetermined period of time, or exhibited a certain slew rate, for example. The power manager 124 may analyze the parameters of the moisture detection signal while making reference to the parameter table 122, which may store predetermined thresholds, slew rates, or timing aspects attributed to moisture or levels of moisture detected by the moisture detector 160. As one example, if the moisture detection signal is greater than a certain threshold, then the power manager 124 may determine that there is a high probability for damage. As another example, if the moisture detection signal has changed by more than a predetermined amount over a certain period of time, then the power manager 124 may determine that there is a high probability for damage. In either case, the power manager 124 may proceed to perform a quick power down of the host device 100. It is also noted that, in various embodiments, the power manager 124 may calculate one or more parameters of a moisture detection signal with reference to data stored in the parameter table 122. For example, the power manager 124 may calculate a relative level of moisture attributed to a moisture detection signal, with reference to a data table or algorithm stored in the parameter table 122.

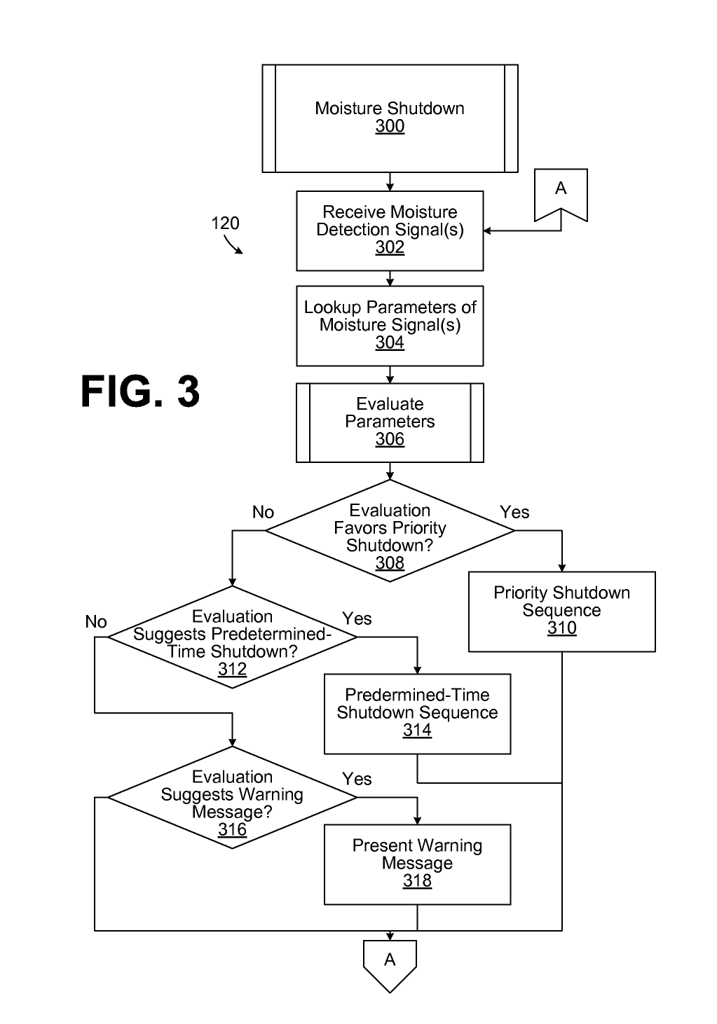

In some cases, if the power manager 124 determines that there is a high probability for damage to a certain circuit element due to moisture, then the power manager 124 may proceed to perform a quick power down of only that circuit element, while the remaining circuit elements of the host device 100 remain powered on. In still other cases, if the power manager 124 determines that there is a relatively low probability for damage, then the power manager 124 may direct the host controller 110 to display a warning message, or perform an orderly shutdown of the host device 100. These and other cases of power down procedures, as directed by the power manager 124, are described in further detail below with reference to FIGS. 3-5.

FIG. 2 illustrates relative positions of subsystem components and sensors in the host device 100 of FIG. 1 in a cross-section the host device 100, according to various embodiments described herein. As shown in FIG. 2, the host device 100 includes several circuit elements 211-215 mounted to a substrate 240. The circuit elements 211-215 may comprise integrated and packaged circuit elements. It should also be appreciated that, in various embodiments, the host device 100 may include additional circuits, integrated and discrete, mounted to the substrate 240.

In FIG. 2, the power controller 120, the display 130, and the battery 140 are also illustrated. The power controller 120, in the example of FIG. 2, is encapsulated by a resin capsule 220. The resin capsule 220 serves to provide at least some protection from environmental conditions for the power controller 120. The resin capsule 220 may prevent the power controller 120 from becoming wet, for example, or from changing temperature quickly due to changed environmental conditions. The resin capsule 220 may be formed from epoxy, silicone, latex, or any other resin or substance suitable for the application.

It is noted that, while the resin capsule 220 provides some protection from water damage, it may not be suitable for use on every circuit element of the host device 100. For example, use of a resin capsule on circuitry of the wireless communications subsystem 152 (FIG. 1) may cause the wireless communications subsystem 152 to overheat, leading to poor operation and/or failure. Thus, in certain exemplary embodiments, the resin capsule 220 may be used to protect the power controller 120, while other circuit elements of the host device 100 are not protected.

Moisture detectors 230-234 are also illustrated in FIG. 2 at respective positions about the host device 100. As the illustration of FIG. 2 is provided by way of example, it is noted that the relative and absolute positions of the moisture detectors 230-234 in FIG. 2 are provided by way of example only. In other words, among embodiments, the moisture detectors 230-234 may be positioned at any location, with preference for locations suitable to detect moisture proximate to sensitive circuitry and/or for early detection of moisture on or near the host device 100. Some moisture detectors, such as detectors 232 and 234, may extend to an outer case of the host device 100. Such moisture detectors may be positioned at one or more locations of the host device 100 that are likely to be the first to enter or fall into an area that is wet. For example, the moisture detector 234 is located at an end of the host device 100 that is likely to be the first to fall into an area that is wet, due to the center of gravity of the host device, for example, or other factors. These detectors may be especially useful for the early detection of moisture on the host device 100. Internal detectors, on the other hand, may be positioned proximate to sensitive circuitry mounted to the substrate 240. In FIG. 2, for example, the moisture detector 231 is mounted to the substrate 240 at a position proximate to the circuit element 213.

Referring next to FIGS. 3-5, flowcharts illustrating example operations of the power controller 120 of the host device 100 of FIG. 1 are provided. In certain aspects, the flowcharts of FIGS. 3-5 may be viewed as depicting example steps of a method of moisture shutdown control. Although the processes of FIGS. 3-5 are described in connection with host device 100 of FIG. 1, other devices may operate according to the processes illustrated. Further, it should be understood that the flowcharts of FIGS. 3-5 provide only examples of different functional or process arrangements that may be employed according to the embodiments described herein.

FIG. 3 illustrates an example process flow of a process 300 for moisture shutdown control performed by the power controller 120 of the host device 100 of FIG. 1 according to various embodiments described herein. At reference numeral 302, a moisture detection signal is received from a moisture detector. For example, the power manager 124 of the power controller 120 receives a moisture detection signal or other indicator of moisture from the moisture detector 160. The moisture detection signal indicates that the moisture detector 160 has detected moisture. As described above, the moisture detector 160 may provide a moisture detection signal indicating a relative level of moisture proximate to or in contact with the moisture detector 160.

In some embodiments, where the moisture detector 160 comprises more than one moisture detector, the power manager 124 may receive more than one signal indicating the detection of moisture at reference numeral 302. In this case, the power manager 124 operates with reference to each of the moisture detection signals received. For example, depending upon which sensors provide signals indicating the detection of moisture, the power manager 124 may power down certain areas or subsystems of circuitry of the host device 100, based on an evaluation of a combination of the feedback signals from the moisture detectors.

Continuing to reference numeral 304, the process 300 includes identifying or accessing parameters or variables associated with the moisture detector 160 and/or the moisture detection signal received from the moisture detector 160. For example, at reference numeral 304, the power manager 124 references the parameter table 122 to identify or access parameters or variables associated with the moisture detector 160. Additionally or alternatively, the power manager 124 references the parameter table 122 to identify or access parameters associated with the moisture detection signal received from the moisture detector 160 at reference numeral 302. The parameter table 122 may include data related to a relative location of the moisture detector 160, acceptable or unacceptable levels or ranges of moisture that may be detected by the moisture detector 160, and/or the potential or probability for damage to the host device 100 based on moisture being detected by the moisture detector 160.

In various embodiments, the parameter table 122 may also store information related to the criticality of circuitry located proximate to the moisture detector 160. Alternatively or additionally, the parameter table 122 may store information related to the vulnerability of circuitry located proximate to the moisture detector 160. Using this information, the power manager 124 can evaluate the probability or likelihood for damage to the host device 100, when a moisture detection signal is received from the moisture detector 160.

In the case that the moisture detector 160 comprises more than one detector, the parameter table 122 may indicate a relative location of each of the detectors, acceptable or unacceptable levels or ranges of moisture that may be detected by each of the moisture detectors, and/or the potential or probability for damage to the host device 100 based on moisture being detected by each of the detectors. The power manager 124 may reference the parameter table 122 for each detector that provides a moisture detection signal.

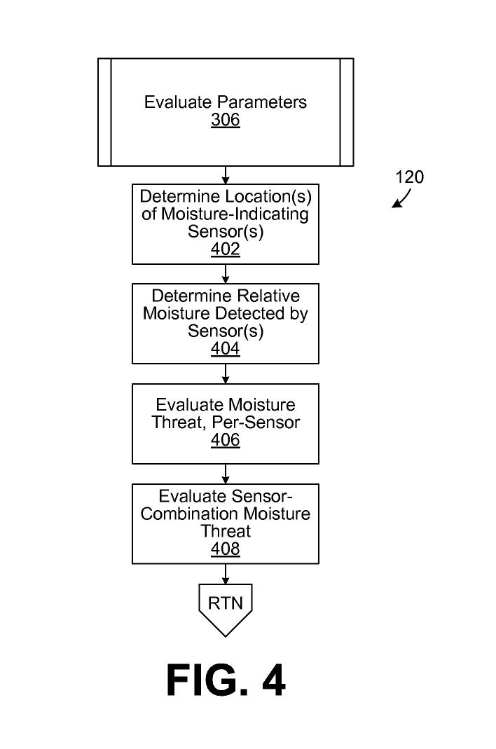

After reference numeral 304, the process 300 proceeds to reference 306, which includes evaluating the parameters identified or accessed at reference numeral 304. In one embodiment, the power manager 124 evaluates the parameters retrieved from the parameter table 122 in connection with the signal indicating the detection of moisture received from the moisture detector 160. Again, it is noted that, if the moisture detector 160 comprises more than one detector, at reference 306, the power manager 124 may evaluate parameters for each of the detectors that provided a signal indicating the detection of moisture. Further aspects of the evaluation of moisture detector parameters at reference numeral 306 are described below with reference to FIG. 4.

After evaluating parameters at reference numeral 306, the process 300 proceeds to reference numeral 308, for determining whether to process a priority shutdown sequence. For example, where the power manager 124 determines whether the evaluation performed at reference numeral 306 favors a priority shutdown sequence. As described herein, a priority shutdown sequence comprises a procedure in which the host device 100 is powered off relatively quickly and, in some aspects, without concern for any processes being executed on the host controller 110 of the host device 100. As one example, an evaluation that favors a priority shutdown sequence may result from an evaluation that identifies a probability for imminent (or nearly imminent) damage to one or more circuit elements of the host device 100. In one embodiment, if the evaluation at reference numeral 304 determines conditions in which the probability of catastrophic damage to the host device 100 is greater than a predetermined threshold, then the power manager 124 may determine at reference numeral 308 that a priority shutdown is necessary.

If it is determined at reference numeral 308 that a priority shutdown is suggested to avoid damage, then the process 300 proceeds to reference numeral 310, which includes initiating a priority shutdown sequence to power down the host device 100. The priority shutdown sequence may be completed, for example, by the power manager 124 controlling the switch 128 (FIG. 1) to disconnect power from the power conditioner 126 and/or the battery 140 from one or more circuit elements within the host device 100. Here, it is noted that the priority shutdown sequence at reference numeral 310 is designed to remove power from one or more circuit elements of the host device 100 as quickly as possible. Under certain circumstances, quick disconnection of power from the circuit elements of the host device 100 upon the detection of moisture provides the best chance for preventing damage (sometimes irreparable damage) from being caused to the host device 100.

In certain embodiments, even in a priority shutdown sequence, power may be maintained to the power controller 120 and/or other circuit elements of the host device 100. For example, referring back to FIG. 2, if moisture is detected by the moisture detector 230, then the evaluation of parameters at reference numeral 306 may result in a finding that the circuit element 211 should be quickly disconnected from power based on its proximity to the moisture detector 230. However, the evaluation may determine that it is not a priority to disconnect other circuit elements from power. Similarly, referring back to FIG. 1, any one or more of the subsystems 152, 154, 156, and 158 may be disconnected from power while the others are not disconnected. In this case, the host device 100 may maintain a certain level of functionality even during a priority shutdown. This may be beneficial if, for example, the host controller 110 is operating on sensitive or critical data. In other words, although some functions of the host device 100 may be unavailable due to the priority shutdown, the sensitive or critical data being processed by the host controller 110 might be saved before the host controller 110 is powered down.

Referring again to reference numeral 308 of FIG. 3, if the power manager 124 determines that a priority shutdown is not necessary, then the process 300 proceeds to reference numeral 312 for determining whether to process a priority shutdown or predetermined-time shutdown sequence. At reference numeral 312, the power manager 124 determines whether the evaluation of parameters at reference numeral 306 suggests that a predetermined-time shutdown sequence is suggested to prevent damage. If the power manager 124 determines at reference numeral 312 that a predetermined-time shutdown sequence is suggested, then the process 300 proceeds to reference numeral 314, where the power manager 124 performs a predetermined-time shutdown sequence.

In a predetermined-time shutdown sequence, one or more circuit elements of the host device 100 may be disconnected from power by the power manager 124 within a predetermined time. For example, as part of the predetermined-time shutdown sequence at reference numeral 314, the power manager 124 may indicate to the host controller 110 that power to one or more of the subsystems 152, 154, 156, or 158 of the host device 100 will be disconnected from power within a predetermined period of time. This indication may be made to the host controller 110 by an interrupt or other suitable general purpose input/output pin of the host controller 110.

Based on the interrupt, an underlying process or application of the host controller 110 may identify that the power manager 124 is performing a predetermined-time shutdown sequence for one or more circuits of the host device 100. In response, the underlying process or application may display a message on the display 130 indicating that moisture has been detected and that one or more circuits or subsystems of the host device 100 will power down within a certain period of time. In this case, the predetermined-time shutdown sequence may permit enough time for the host controller 110 to save data, close certain ongoing applications, and generally wind down certain processes, before circuitry is disconnected from power. Thus, data loss may be prevented.

Meanwhile, the power manager 124 may wait a predetermined amount of time before controlling the switch 128 to disconnect power from one or more circuit elements of the host device 100. It is noted that, in the predetermined-time shutdown sequence 314, it may not be necessary to disconnect all circuit elements of the host device 100 from power. Instead, in certain embodiments, only circuit elements or subsystems for which a high probability of damage is likely may be disconnected from power.

Referring again to reference numeral 312 of FIG. 3, if the power manager 124 does not determine that a predetermined-time shutdown is suggested, then the process 300 proceeds to reference numeral 316. At reference numeral 316, the power manager 124 determines whether the evaluation of the parameters at reference numeral 306 suggests that a warning message should be presented on the display 130 of the host device 100. If so, the process 300 proceeds to reference numeral 318, where the power manager 124 provides an indication to the host controller 110 that a display warning should be provided. On the host controller 110, an underlying process or application may identify the indication that a display warning should be provided. In this context, at reference numeral 318 the host controller 110 may display a warning message on the display 130. In various embodiments, the warning message may indicate to a user of the host device 100 that moisture has been detected by one or more sensors of the host device 100. The warning message may also indicate that the host device 100 should be moved to an environment that is relatively dry or powered down to reduce the possibility of damage. In other aspects, additionally or alternatively to the display warning at reference numeral 318, an audible or haptic feedback warning may be provided by the host device 100.

Referring back to reference numeral 316, if the power manager 124 determines that the evaluation of parameters at reference numeral 306 does not suggest that a warning message should be presented, then the process 300 proceeds back to reference numeral 302 to await receipt of a moisture detection feedback signal from the moisture detector 160. Thus, as an ongoing operation of the power controller 120, the power manager 124 may monitor for moisture detection signals and direct the supply of power to circuit elements of the host device 100.

Generally, the power manager 124 seeks to reduce damage that may be caused by an unacceptable level of moisture being exposed on or within the host device 100, by quickly powering down the host device 100 if moisture exposure is high or proximate to critical components. On the other hand, if exposure to moisture appears to be low or not proximate to critical circuitry of the host device 100, then the power manager 124 operates to power down the host device 100 without any loss of data, for example, in the host controller 110. Similarly, if exposure to moisture is only on the exterior of the host device 100 and limited enough so as not to cause damage, then the power manager 124 may provide a warning to a user of the host device 100. In turn, the user may take remedial measures to prevent the host device 100 from being exposed to additional moisture. Especially for moisture detectors that are sensitive and may be triggered by very limited amounts of moisture or even high humidity, for example, the process 300 provides a relatively balanced approach between protecting the host device 100 and protecting data being processed by the host device 100.

FIG. 4 illustrates an example process flow of the process 306 of FIG. 3 for evaluating parameters for moisture shutdown, performed by the power controller 120 of the host device 100 of FIG. 1 according to various embodiments described herein. At reference numeral 402, the process 306 includes determining a relative location of a moisture-indicating sensor. For example, the power manager 124 references the parameter table 122 (FIG. 1) to determine a relative location of the moisture detector 160. In various embodiments, the location information may indicate that the moisture detector 160 is located internal or external to an outer case of the host device 100, located proximate to one or more circuits within the host device, or located at a position that is or is not associated with a particular vulnerability to moisture. As noted above, if the moisture detector 160 comprises more than one detector, and more than one signal indicating moisture is received, then the power manager 124 may reference the parameter table 122 for each of the detectors at reference numeral 402.

Continuing to reference numeral 404, the process 306 includes determining or calculating a relative amount of moisture detected by a moisture sensor. For example, the power manager 124 determines or calculates a relative amount of moisture detected by the moisture detector 160. In various embodiments, the determination of the relative amount of moisture detected may be performed with reference to a lookup table stored in the parameter table 122. For example, a certain signal level received from the moisture detector 160 may be related to a certain amount or level of moisture or wetness, and the power manager may rely upon the parameter table 122 to lookup, reference, or calculate the amount of moisture associated with the certain signal level. In this context, the power manager 124 may also reference the parameter table 124 to determine or calculate whether the certain signal level received by the moisture detector 160 is related to one or more acceptable or unacceptable levels of moisture for the host device 100. Again, if the moisture detector 160 comprises more than one detector, and more than one moisture detection signal is received, then the power manager 124 may reference the parameter table 122 for each of the detectors at reference numeral 404.

After reference numeral 404, the process 306 proceeds to reference numeral 406, for evaluating a threat of moisture. For example, where the power manager 124 evaluates the threat of moisture based on the determinations made at reference numerals 402 and 404. In various embodiments, the evaluation may be performed to balance protection of the host device 100 from damage due to moisture and protecting data being processed by the host device 100. For example, if the relative amount of moisture detected by the moisture detector 160 is determined to be high at reference numeral 402 and the location of the moisture detector 160 is determined to be a vulnerable one at reference numeral 404, then the power manager 124 may determine a high probability for catastrophic or irreparable damage to the host device 100 at reference numeral 406. On the other hand, if the relative amount of moisture detected by the moisture detector 160 is determined to be low at reference numeral 402 and the location of the moisture detector 160 is determined to be exterior to a case of the host device 100 at reference numeral 404, the power manager 124 may determine a low probability for catastrophic or irreparable damage at reference numeral 406. At reference numeral 406, if the moisture detector 160 comprises more than one detector, then the evaluation may be performed for each detector.

In other aspects of the evaluation of the threat of moisture at reference numeral 406, it is noted that a temperature measured by the temperature sensor 164 of the host device 100 may be taken into account. As described above, the temperature sensor 164 may provide a signal to the power controller 120 that indicates a temperature of an area of the host device 100. When the temperature of the area of the host device 100 is high, for example, the power manager 124 may arrive at an evaluation of a higher a probability for damage to the host device 100 at reference numeral 406, especially if moisture is detected proximate to the area of high temperature.

After reference numeral 406, in the case that the moisture detector 160 comprises more than one detector, the process 306 proceeds to reference numeral 408, for evaluating a threat of moisture based on a combination of the determinations made at reference numerals 402, 404, and 406. For example, where the power manager 124 evaluates the threat of moisture based on a combination of the determinations made at reference numerals 402, 404, and 406. That is, when more than one moisture detector indicates the presence of moisture, any interplay among the detectors is evaluated at reference numeral 406. For example, if two moisture detectors proximate to each other identify similar amounts of moisture, then the power manager 124 may attribute a higher level of confidence to the respective measurements made by each. Alternatively, if two moisture detectors proximate to each other identify different amounts of moisture, then the power manager 124 may attribute a lower level of confidence to the respective measurements made by each. Thus, the power manager 124 may adjust the probability of damage to the host device 100 based, in part, upon a combination of feedback signals received from moisture detectors. After reference numeral 408, the process 306 returns or continues at reference numeral 308 of FIG. 3.

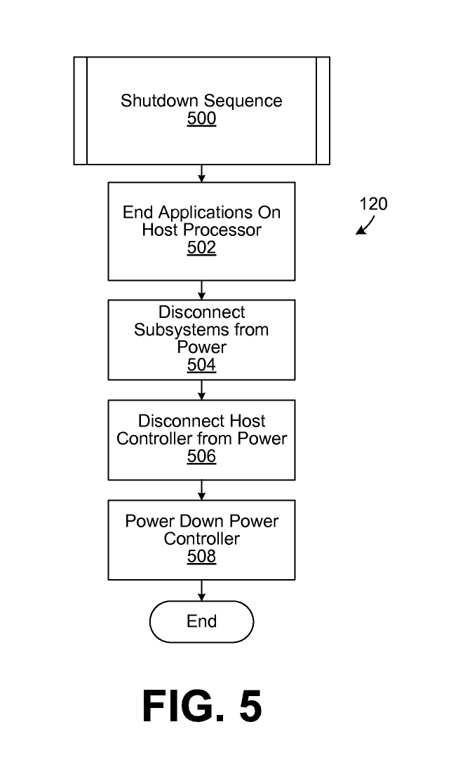

FIG. 5 illustrates an example process flow of a shutdown sequence process 500 performed by the host device 100 of FIG. 1 according to various embodiments described herein. Generally, it is noted that the shutdown sequence process 500 is provided by way of example only, as other shutdown sequences, some described herein, are within the scope and spirit of the embodiments. In certain aspects the shutdown sequence process 500 is similar to the predetermined-time shutdown sequence of reference numeral 314 of FIG. 3. Particularly, at reference numeral 502, applications on the host controller 110 are ended, in response to a signal from the power manager 124 that a predetermined-time shutdown is underway. After a certain period of time, at reference numeral 504, the power manager 124 disconnects the subsystems 152, 154, 156, and 158 of the host device 100 from power. Further, at reference numeral 506, the power manager 124 disconnects the host controller 110 of the host device 100 from power. The disconnections at reference numerals 504 and 506 may be performed by the power manager 124 by control of the switch 128, as described above. Finally, at reference numeral 508, the power controller 120 may disconnect power to itself.

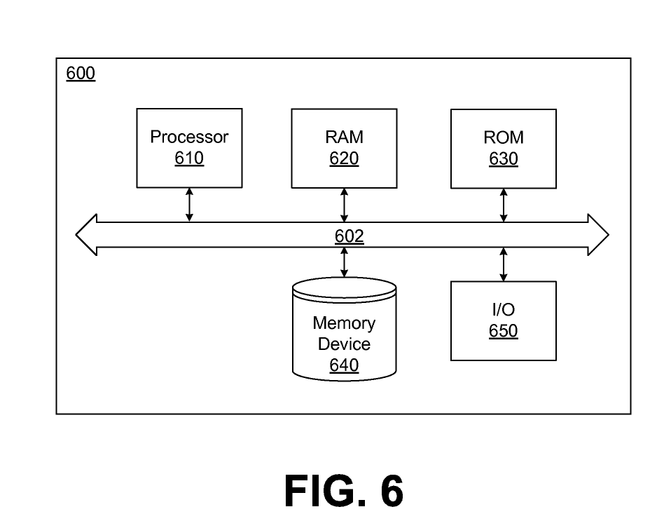

FIG. 6 illustrates an example schematic block diagram of a computing architecture that may be employed by the host device 100 of FIG. 1 according to various embodiments described herein. The computing architecture 600 may be embodied, in part, using one or more elements of a mixed general and/or special purpose computer. The computing device 600 includes a processor 610, a Random Access Memory (RAM) 620, a Read Only Memory (ROM) 630, a memory device 640, and an Input Output (I/O) interface 650. The elements of computing architecture 600 are communicatively coupled via a bus 602. The elements of the computing architecture 600 are not intended to be limiting in nature, as the architecture may further additional or alternative elements.

In various embodiments, the processor 610 may comprise any general purpose arithmetic processor, state machine, or Application Specific Integrated Circuit (ASIC), for example. In various embodiments, the host controller 110 and/or or the power manager 124 of FIG. 1 may be implemented, in part, by the processor 610. The processor 610 may include one or more circuits, one or more microprocessors, ASICs, dedicated hardware, or any combination thereof. In certain aspects and embodiments, the processor 610 is configured to execute one or more software modules. The processor 610 may further include memory configured to store instructions and/or code to perform various functions, as further described herein. In certain embodiments, the processes described in FIGS. 3-5 may be implemented or executed by the processor 610.

The RAM and ROM 620 and 630 comprise any random access and read only memory devices that store computer-readable instructions to be executed by the processor 610. The memory device 640 stores computer-readable instructions thereon that, when executed by the processor 610, direct the processor 610 to execute various aspects of the embodiments described herein.

As a non-limiting example group, the memory device 640 comprises one or more of an optical disc, a magnetic disc, a semiconductor memory (i.e., a semiconductor, floating gate, or similar flash based memory), a magnetic tape memory, a removable memory, combinations thereof, or any other known non-transitory memory means for storing computer-readable instructions. The I/O interface 650 comprises device input and output interfaces, such as keyboard, pointing device, display, communication, and/or other interfaces. The bus 602 electrically and communicatively couples the processor 610, the RAM 620, the ROM 630, the memory device 640, and the I/O interface 650, so that data and instructions may be communicated among them.

In certain aspects, the processor 610 is configured to retrieve computer-readable instructions and data stored on the memory device 640, the RAM 620, the ROM 630, and/or other storage means, and copy the computer-readable instructions to the RAM 620 or the ROM 630 for execution, for example. The processor 610 is further configured to execute the computer-readable instructions to implement various aspects and features of the embodiments described herein. For example, the processor 610 may be adapted or configured to execute the processes described above with reference to FIGS. 3-5. In embodiments where the processor 610 comprises a state machine or ASIC, the processor 610 may include internal memory and registers for maintenance of data being processed.

The flowcharts or process diagrams of FIGS. 3-5 are representative of certain processes, functionality, and operations of embodiments described herein. Each block may represent one or a combination of steps or executions in a process. Alternatively or additionally, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as the processor 610. The machine code may be converted from the source code, etc. Further, each block may represent, or be connected with, a circuit or a number of interconnected circuits to implement a certain logical function or process step.

Although the flowcharts or process diagrams of FIGS. 3-5 illustrate an order, it is understood that the order may differ from that which is depicted. For example, an order of execution of two or more blocks may be scrambled relative to the order shown. Also, two or more blocks shown in succession in FIGS. 3-5 may be executed concurrently or with partial concurrence. Further, in some embodiments, one or more of the blocks shown in FIGS. 3-5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

At least the following is claimed:

1. A method, comprising:
receiving, from a moisture detector associated with a mobile communication device, a moisture detection signal;
identifying a parameter associated with at least one of the moisture detector or the moisture detection signal; and
initiating, in response to the identified parameter, a power down procedure to power down at least a portion of the mobile communication device.

2. The method of claim 1, wherein identifying a parameter comprises identifying a location of the moisture detector, a subsystem of the mobile communication device associated with the location of the moisture detector, and a probability for damage to the subsystem of the mobile communication device.

3. The method of claim 2, further comprising determining whether to display a shutdown recommendation message based on the probability for damage.

4. The method of claim 2, further comprising determining whether to process a priority shutdown or predetermined-time shutdown sequence based on the probability for damage.

5. The method of claim 1, wherein initiating a power down procedure comprises following a power down sequence comprising application, subsystem, and host power down processes.

6. The method of claim 5, wherein the application power down process comprises displaying a moisture shutdown message that indicates shutdown of the at least a portion of the mobile communication device within a predetermined period of time.

7. The method of claim 1, wherein:
the moisture detector comprises a plurality of moisture detectors;
receiving a moisture detection signal comprises receiving, from at least two of the plurality of moisture detectors, at least two moisture detection signals; and
initiating a power down procedure further comprises initiating the power down procedure based on a combination of the at least two moisture detection signals.

8. The method of claim 1, wherein:
the method further comprises receiving, from a temperature detector of the mobile communication device, a signal indicating a temperature of at least one area of the mobile communication device;
the moisture detection signal indicates a relative level of the moisture;
identifying a parameter comprises identifying a location of the moisture detector, a subsystem of the mobile communication device associated with the location of the moisture detector, and a probability for damage to the subsystem of the mobile communication device based on the relative level of the moisture and the temperature of the at least one area of the mobile communication device; and
the method further comprises determining whether to process a priority shutdown or predetermined-time shutdown sequence based on the probability for damage.

9. A mobile communication device, comprising:
a moisture detector that detects a relative level of moisture;
a host controller that coordinates operation of the mobile communication device; and
a power controller that:
coordinates a supply of power from a battery to subsystems of the mobile communication device;
identifies a parameter associated with at least one of the moisture detector or a moisture detection signal received from the moisture detector, in response to receipt of the moisture detection signal; and
based on the identified parameter, disconnects the supply of power from the battery.

10. The mobile communication device of claim 9, wherein the power controller further identifies a location of the moisture detector, a subsystem of the mobile communication device associated with the location of the moisture detector, and a probability for damage to the subsystem of the mobile communication device based on the relative level of the moisture.

11. The mobile communication device of claim 10, wherein the power controller further determines whether to display a shutdown recommendation message based on the probability for damage.

12. The mobile communication device of claim 10, wherein the power controller further determines whether to process a priority shutdown or predetermined-time shutdown sequence based on the probability for damage.

13. The mobile communication device of claim 9, wherein the power controller further initiates a power down procedure comprising application, subsystem, and host power down processes.

14. The mobile communication device of claim 13, wherein, during the application power down process, the host controller further displays a moisture shutdown message that indicates shutdown of the mobile communication device within a predetermined period of time.

15. The mobile communication device of claim 9, wherein:
the moisture detector comprises a plurality of moisture detectors; and
the power controller further receives a moisture detection signal from at least two of the plurality of moisture detectors and initiates a power down procedure based on a combination of the at least two moisture detection signals.

16. A method, comprising:
receiving a moisture detection signal;
identifying, with a controller, a parameter associated with at least one of the moisture detection signal or a moisture detector associated with the moisture detection signal; and
based on the identifying, initiating a power down procedure to power down at least a portion of a mobile communication device based on a probability for damage to the mobile communication device.

17. The method of claim 16, wherein identifying a parameter comprises identifying a location of the moisture detector, a subsystem of the mobile communication device associated with the location of the moisture detector, and a probability for damage to the subsystem of the mobile communication device.

18. The method of claim 16, further comprising determining whether to display a shutdown recommendation message, process a priority shutdown sequence, or process a predetermined-time shutdown sequence based on the probability for damage.

19. The method of claim 18, wherein processing the predetermine-time shutdown sequence comprises application, subsystem, and host power down processes.

20. The method of claim 16, wherein:
receiving a signal comprises receiving at least two moisture detection signals; and
initiating a power down procedure further comprises initiating the power down procedure to power down at least the portion of the mobile communication device based on a combination of the at least two moisture detection signals.
